(19) United States
(12) Patent Application Publication
(10) Pub. No.: US 2009/0034778 A1
(43) Pub. Date: Feb. 5, 2009

(54) Multimedia luminous speaker

(75) Inventor: Hwa-Jei Chi, Taipei (TW)

Correspondence Address: PUR TECHNOLOGY CORPORATION, P.O. BOX 166-13, TAIPEI, 115, TW

(73) Assignee: PUR TECHNOLOGY CORPORATION

(21) Appl. No.: 11/882,471

(22) Filed: Aug. 2, 2007

(51) Int. Cl. H04R 1/02

(52) U.S. Cl. 381/394; 381/386; 381/395

(57) ABSTRACT

This present invention relates to a multimedia luminous speaker comprising: a speaker base (2); at least a speaker (3) installed on the speaker base (2); a control circuit (5) installed inside the speaker base (2) electrically connected to the speaker (3); at least, an LED (53) installed inside the speaker base (2) electrically connected to the control circuit (5); a transparent or semi-transparent shade (1) coupled to the speaker base (2) keeps a distance to the LED (53) in the speaker base (2); the shade (1) has a hollow shade (12) made of plastic; the shade (1) fixed to the speaker base (2) by a bolt (11) fit through a central bore at a proximal end of the hollow shade (12) and then a distal end of the bolt (11) screwed to the speaker base (2).

### FIELD OF THE INVENTION

The present invention is related to a multimedia luminous speaker with auditory-visual integration performance.

### BACKGROUND OF THE INVENTION

The modern society becomes now, following by more pressure. Entertainment becomes a good way to do relaxation. Listening to music is one of popular leisure activities familiar to most of the audiences. However, music broadcasting in, the speaker is requested to provide performance as well as sound quality, but lack of visual achievement. In general, an auditory-visual integration performance required the other light-emission equipments in connection with the speaker. With advanced stereo effect, those added cords and accessories may incur more expenses.

Accordingly, TW M241927 entitled “speaker with light emitting effect” assigned to Ching-Tang Chen on Aug. 21, 2004; Chen stated a luminous speaker includes a box, a speaker, and light emitting diodes (LED(s)). Once the speaker is switched on, an electric circuit conducting current lights LED(s), of which light emission may be influenced by the speaker's sound frequency. By then it demonstrates audio and visual effects.

The defect of TW M241927 is, when powered, this electric circuit is immediately to light the LED(s). Whether the LED(s) come to light or not as desired is not concerned by the prior art. In addition, inside the speaker, there has no built-in light mask. Therefore, the LED(s) emit light directly as distinct interference patterns to the ambient light; users could not look straight to the lit speaker. The speaker is not able to connect to another speaker or power source, music broadcasting in the speaker is limited to an extension: either location of the speaker, or output power of the speaker is a sole performance, but no extension units can be added thereto.

### SUMMARY OF THE INVENTION

Accordingly, a primary object of the present invention is to provide a multimedia luminous speaker with a lot of lit dots shining with changing light colors, and users can look straight to the speaker.

A secondary object of the present invention is to provide a hollow shade fixed to a speaker base.

Point against aforesaid problems, the present invention is to provide a multimedia luminous speaker comprising: a speaker base (2); at least a speaker (3) installed on the speaker base (2); a control circuit (5) installed inside the speaker base (2) electrically connected to the speaker (3); at least, an LED (53) installed inside the speaker base (2) electrically connected to the control circuit (5); a transparent or semi-transparent shade (1) coupled to the speaker base (2) keeps a distance to the LED (53) in the speaker base (2); the shade (1) has a hollow shade (12) made of plastic; the shade (1) fixed to the speaker base (2) by a bolt (11) fit through a central bore at a proximal end of the hollow shade (12) and then a distal end of the bolt (11) screwed to the speaker base (2).

A multimedia luminous speaker as mentioned above wherein a hollow shade is cone-shaped shade consists of a layer (13) pervious to light and a film (14); a first side of the film (14) is a glossy surface (16), and a second side of the film (14) is a textured surface (15), which is processed through rollers to form a lot of tiny concave and convex conic dots.

A multimedia luminous speaker as mentioned above wherein the bolt (11) is made of acrylic or polycarbonate, a distal end of the bolt (11) has a tapered prop (112) with external threads; an apex block (111) is on a proximal end of the bolt (11).

A multimedia luminous speaker as mentioned above wherein the film (14) is attached to the layer (13) pervious to light by the textured surface (15).

A multimedia luminous speaker as mentioned above wherein a film (14) is attached to the layer (13) pervious to light by the glossy surface (16).

A multimedia luminous speaker as mentioned above wherein a film (14) is distributed with a film-like printing layer on the glossy surface (16).

A multimedia luminous speaker as mentioned above wherein the layer (13) pervious to light is made of polyvinyl chloride (PVC), while the film is made of polyethylene (PE).

A multimedia luminous speaker as mentioned above, a multimedia luminous speaker comprising: a speaker base (2) includes a hood (21) made of plastic, a base (23) made of plastic coupled to the hood (21); a socket shield (22) coupled between the hood (21) and a rear end of the base (23); a plastic battery pack (25) opened downward in the base (23); an opening of the plastic battery pack (25) can be sealed by a battery door (24).

A multimedia luminous speaker as mentioned above wherein the control circuit (5) includes a circuit board (51) installed inside the speaker base (2), at least, a switch (4) installed on the circuit board (51) protruded out of the speaker base (2); a light-sensitive knob (54) installed inside the socket shield (22) electrically connected to the circuit board (51), a power jack (56) and several connection ports (55); the circuit board (51) is also electrically connected to batteries (6) in the battery pack (25), LED(s) (53) and the speaker (3).

A multimedia luminous speaker as mentioned above wherein the connection ports (55) can be selected from one of the following or both: a mini USB port (55a), audio line-in port (55b) and audio line-out port (55c).

A multimedia luminous speaker as mentioned above wherein a switch (4) can be selected from one of the following or both: a power switch (41) for the speaker, a volume up button (42), volume down button (43), a knob (44) for adjusting various level of light colors, and a power switch for the LED(s) (45).

A multimedia luminous speaker as mentioned above wherein the circuit board (51) includes an amplifier (57), a kind of file format which can be converted from original audio cd(s) or movie(s) compact disk(s) into file format, can only be read by computers or pocket audio devices, MP3 stands for Moving Picture Experts Group (MPEG) Audio Layer 3/MP4 stands for MPEG 4(MP3/MP4) decoder (58), a system chip (52) of a microprocessor (59) for controlling LED(s) (53) and sound volume of speaker (3) in accordance with audio output signals.

Point against aforesaid problems, another embodiment of the invention is to provide a multimedia luminous speaker comprising a speaker base (2); at least, a speaker (3) installed inside the speaker base (2); a control circuit (5) installed inside the base (2) electrically connected to the speaker (3); at least, an LED(s) (53) installed inside the speaker base (2) electrically connected to the control circuit (5); and a transparent or semi-transparent shade (1) coupled to the speaker base (2) to keep a distance to the LED(s) (53) of the speaker base (2), said shade (1) is a cylindrical container with a trough (182) formed therein.

A multimedia luminous speaker as mentioned above wherein a bracket (181) is extended out of a distal end of the container (18), which is screwed to the base (2) by the bracket (181).

A multimedia luminous speaker as mentioned above wherein a distal end of the container (18) has a hole (183) for inserting through a bolt (184), the container (18) is fixed to a base (2) by a bolt (184).

A multimedia luminous speaker as mentioned above wherein a film (14) is attached to an inner side of the container (18), a first side of the film (14) is a glossy surface (16), a second side of the film (14) is a textured surface (15), which is processed through rollers to form a lot of concave and convex conic dots.

A multimedia luminous speaker as mentioned above wherein the film (14) attached to the container (18) by the textured surface (15).

A multimedia luminous speaker as mentioned above wherein the film (14) attached to the container (18) by the glossy surface (16).

A multimedia luminous speaker as mentioned above wherein a film-like printing layer (196) distributed on the glossy surface (16) of the film (14).

A multimedia luminous speaker as mentioned above wherein the film (14) is made of polyethylene (PE).

A multimedia luminous speaker as mentioned above wherein the base (2) includes a plastic hood (21), a plastic base (23) coupled to the hood (21), and a socket shield (22) coupled between the hood (21) and a rear end of the base (23); the hood has a hole (212) for inserting through the bracket (181) at the distal end of the container (18) to receive the bolt (184) screwed therein; a battery pack (25) opened downward in the base (23); an opening of the battery pack (25) can be sealed by the battery door (24).

Point against aforesaid problems, another embodiment of the invention is to provide a multimedia luminous speaker comprising a speaker base (2); at least a speaker (3) installed inside the speaker base (2); a control circuit (5) installed inside the speaker base (2) electrically connected to the speaker (3); at least an LED(s) (53) installed inside the speaker base (2) electrically connected to the control circuit (5); a transparent or semi-transparent shade (1) disposed on a bracket (191), which is coupled to the speaker base (2); the shade (1) is a hollow adornment (19), in which the LED(s) (53) are hidden from view.

A multimedia luminous speaker as mentioned above wherein the bracket (191) consists of a bolt (193), a supporting plate (192) is placed on a proximal end of the bolt (193).

A multimedia luminous speaker as mentioned above wherein the adornment (19) has a distal end (194) in contact with the bracket (191); the distal end (194) has a gap (195) for receiving the LED(s) (53) into the adornment (19).

A multimedia luminous speaker as mentioned above wherein a surface of the adornment (19) is distributed with a film-like printing layer (196).

A multimedia luminous speaker as mentioned above wherein the base (2) includes a hood (21), a plastic base (23) coupled to the hood (21); a socket shield (22) coupled between the hood (21) and a rear end of the base (23); the hood has a hole (212) for receiving the bracket (191) screwed therein; a battery pack (25) opened downward in the base (23), an opening of the battery pack (25) can be sealed by the battery door (24).

### BRIEF DESCRIPTION OF DRAWINGS OF THE INVENTION

FIG. 1: is a perspective view of the first embodiment of the invention;

FIG. 2: is an exploded view of FIG. 1;

FIG. 3: is a sectional view of FIG. 1;

FIG. 3A: is an enlarged sectional view of the shade of FIG. 1;

FIG. 3B: is another enlarged sectional view of the shade of FIG. 1;

FIG. 4: is a perspective view of the second embodiment of the invention;

FIG. 5: is an exploded view of FIG. 4;

FIG. 5A: is a schematic view of the container coupled to the speaker base;

FIG. 6: is a cross-sectional view of the shade in part used as a pen holder;

FIG. 6A: is a sectional view of one film attached to the container;

FIG. 6B: is a sectional view of the other film attached to the container;

FIG. 7: is a sectional view of FIG. 4 a shade used as a flower vase;

FIG. 8: is an exploded view of the third embodiment of the invention; and

FIG. 9: is a sectional view of FIG. 8 after combination.

### DETAILED DESCRIPTION OF THE PREFERRED EMBODIMENTS OF THE INVENTION

Detailed description is described in detail according to the appended drawings hereinafter.

### First Embodiment

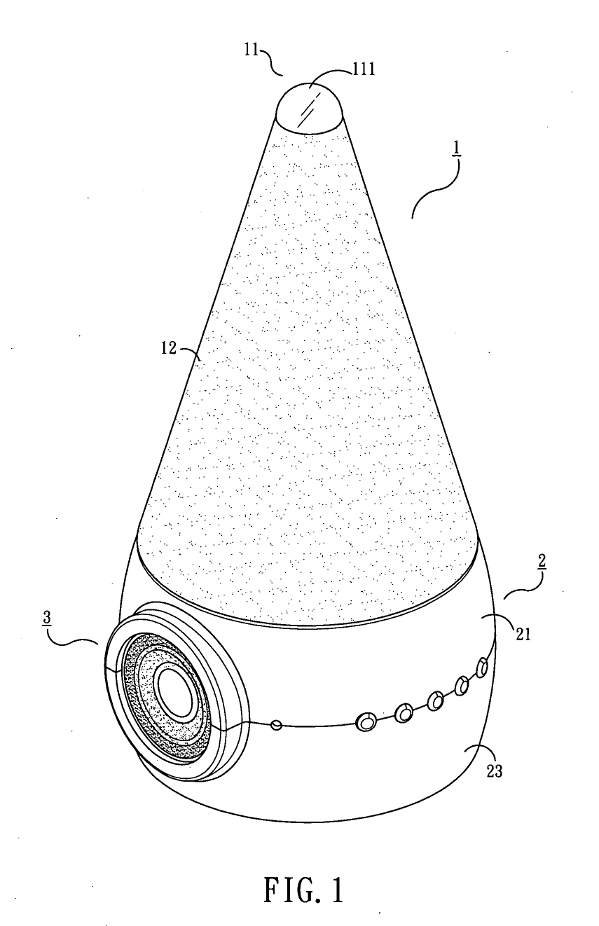

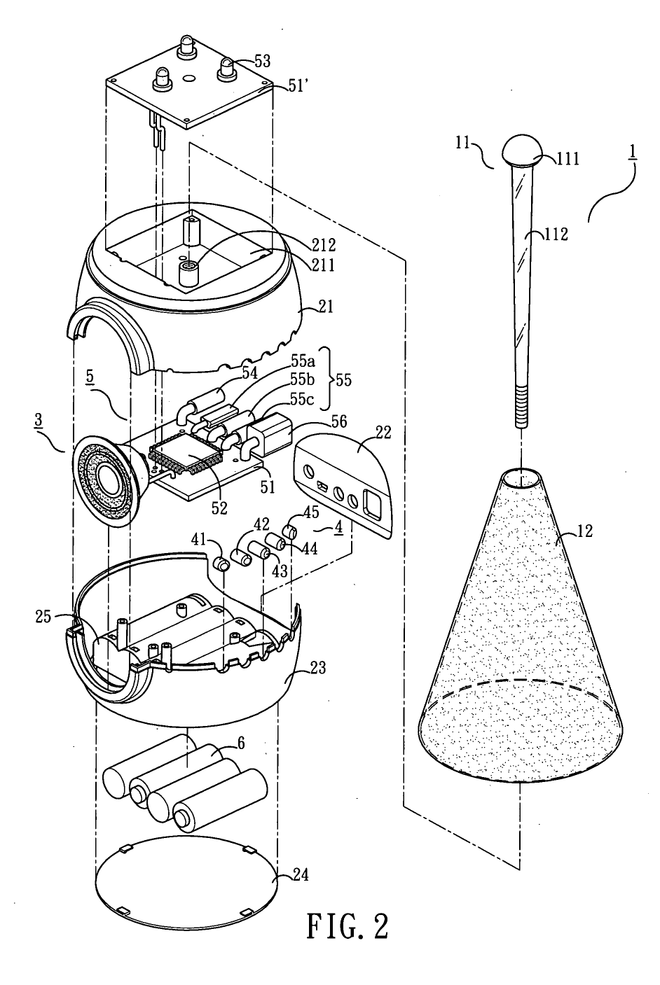

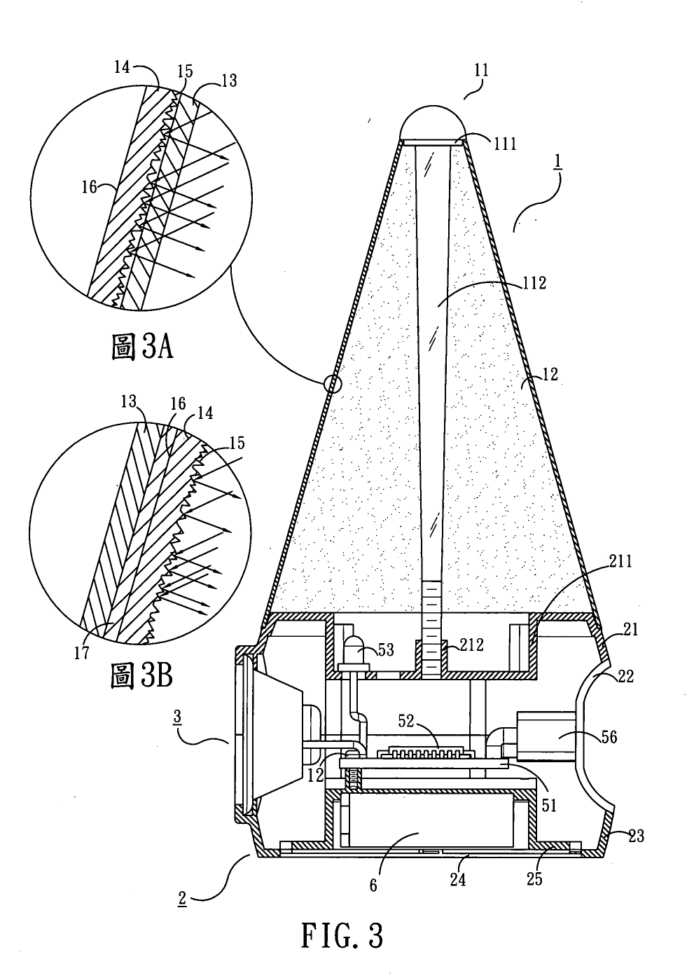

As shown in FIGS. 1˜3, a multimedia luminous speaker includes a speaker base (2); at least a speaker (3) installed inside the speaker base (2); a control circuit (5) installed inside the speaker base (2) is electrically connected to the speaker (3). At least an LED (53) installed on a circuit board (51′) secured to a lateral side of a proximal end of the speaker base (2) is electrically connected to the control circuit (5). A transparent or semi-transparent shade (1) is coupled to the proximal end of the speaker base (2) to keep a distance to the lateral side of the proximal end of the speaker base (2). The shade (1) consists of a hollow shade (12) made of plastic and a bolt (11), at least, pervious to light in part.

As mentioned above, the hollow shade (12) consists of a single side of a layer (13) pervious to light coupled with a film (14). A first side of the film (14) has a glossy surface (16), while opposite to the first side, a second side of the film (14) has a textured surface (15). The textured surface (15) is processed through rollers to form a lot of tiny concave and convex conic dots to reflect light emission. The bolt (11) is made of acrylic or polycarbonate; which are pervious to light, at least, in part. The bolt (11) has a tapered prop (112) with external threads formed thereon at a distal end, and an apex block (111) shaped on a proximal end of the bolt (11). The textured surface (15) of the film (14) is processed through rollers by pressing to form a lot of tiny conic dots, which are distributed on the textured surface evenly with each apex projected upward or downward over the textured surface. In other words, the conic dots are shaped with each “apex” projected outward, or caved inward on the textured surface (15). LED(s) may emit light on the textured surface (16) and reflect through those tiny conic dots to form a lot of speckles (lighting dots). Furthermore, those speckles on both concave and convex shaped conic dots may be mixed up to show a hazy atmosphere. In addition, a blurred vision incorporated to music broadcast in the speaker as an auditory-visual integration performance, users may be amused.

As mentioned above, the film (14) is attached to the layer (13) pervious to light by the textured surface (13). Opposite to the textured surface, the glossy surface (16) is exposed outward on an outer surface of the film (14), which is further laminated to the layer (13). Thus, the glossy surface (16) can filter light reflecting or refracting throughout the layer (13), by which the film (14) is to process flashing sequence patterns of the LED(s) other than the same interfere with ambient light.

As mentioned above, the film (14) is attached to the layer (13) pervious to light by the glossy surface (16). The layer (13) pervious to light is a substrate, of which a smooth surface can be laminated with the glossy surface (16) of the film. Opposite to the glossy surface, the textured surface (15) of the film (14) can be used to reflect light. Furthermore, when bumped or detached, the film (14) is not easy to peel off from the layer (13) pervious to light.

Next, the glossy surface (16) of the film (14) is distributed with film-like printing layer (196), which is formed with characters, patterns, and marks by screen printing with fine pitch printability. It will not affect transparency of shade (1).

As mentioned above, the layer (13) pervious to light is made of polyvinyl chloride (PVC), which is inexpensive, durable in use, but with sufficient flexibility. A thickness of the layer (13) is in the range of 0.15˜0.5 mm, by which a certain degree of transparency, flexibility, and strength is endowed to prevent from deformation when bumped.

As mentioned above, a film (14) is made of polyethylene, which is provided with fine pitch printability, high transparency, and to be a better insulation material. The film (14) can be a flexible and durable material in use. But it is inexpensive so that it can be widely used in the invention. A thickness of the film is in the range of 0.15˜0.5 mm. Such a slim film (14) is endowed with a certain degree of flexibility and strength without mechanical deformation. And a plastic deformation happened to the film can be recovered.

As mentioned above, the bolt (11) is selected from one of the following: a transparent plastic material or a semi-transparent plastic material. The light emission should not be altered or obstructed by the bolt (11); however, all the light emission can be easily reflected to the shade (1) without interrupting by a bolt (11).

As mentioned above, the LED (53) can be full of LED colors, or single LED color to fit in different occasions.

As mentioned above, a speaker base (2) includes a holder (211), a plastic hood (21) fits around the holder (211) and a hole (212) at a center, a base (23) fits around a plastic battery pack (25), which is concaved downward for receiving several batteries therein. The hood 21 is corresponding to the battery base (23) in an upward and downward relationship; they are combined integrally to form a house. A socket shield (22) installed between the hood (21) and the base (23). In addition, the plastic battery pack (25), a battery door (24) can be applied to cover an opening of the battery pack (25); the opening is opened downward. Whereby, the shade (1) and, at least, one LED (53) can be installed on the house securely, further to enhance extra protection and to provide external power, easy to carry-on.

As mentioned above, a control circuit (5) includes a circuit board (51) which is installed between the hood (21) and the base (23). The circuit board (51) is electrically connected to batteries (6) in the battery pack (25), LED (53) in the speaker base (2) and the speaker (3). At least a switch (4) installed to a lateral side of the house is protrude out of the speaker base (2). A light-sensitive knob (54) installed inside the socket shield (22) is electrically connected to the circuit board (51), a power jack (56), and at least a connection port (55). The electric circuit (5) is mainly to connect to various connection ports (55) and switches (4) to adapt to other equipments to provide various entertainments.

As mentioned above, a connection port (55) can be selected from one of the following: a mini Universal Serial Bus (USB) port (55a), an audio line-in port (55b), an audio line-out port (55c).

As mentioned above, a switch (4) can be selected from one of the following: a power switch for the speaker (41), a volume up button (42), a volume down button (43), a knob (44) for adjusting various level of light color, and a power switch for the LED(s) (45).

The multimedia luminous speaker of the invention can be connected to a kind of file format which can be converted from original audio cd(s) or movie(s) compact disk(s) into file format, can only be read by computers or pocket audio devices, MP3 stands for Moving Picture Experts Group (MPEG) Audio Layer 3/MP4 stands for MPEG 4 (MP3/MP4) player (not shown), where an audio cord (not shown) is directly connected between the audio line-in port (55b) of the speaker and the player. Further the audio line-out port (55b) of the speaker is to output and connect to another multimedia luminous speaker audio line-in port (55b). Whereby more than one multimedia luminous speakers can be connected in series to broadcast and illuminate at the same time. A bolt (11) made of acrylic or polycarbonate, which is, at least, transparent in part, light transmission through the bolt by means of reflection or refraction. By then, light transmission is therefore directed to an apex block (111). And a lot of tiny concave and convex conic dots distributed on a hollow shade (12) of the shade (1) shine and reflect mild light. Moreover, a printing layer (196) on the glossy surface (16) is formed with characters, patterns, and marks to show various messages. The speaker is therefore to provide auditory-visual achievements, which is not confined by the prior arts.

### Second Embodiment

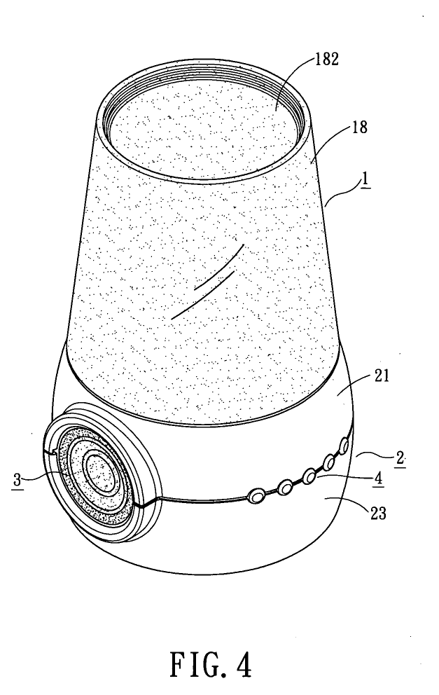

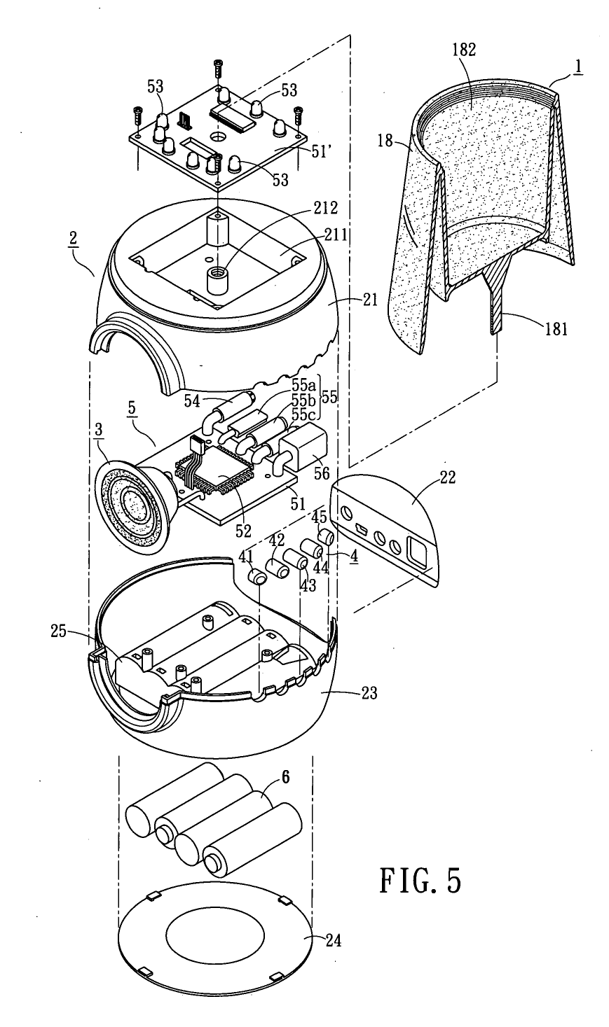

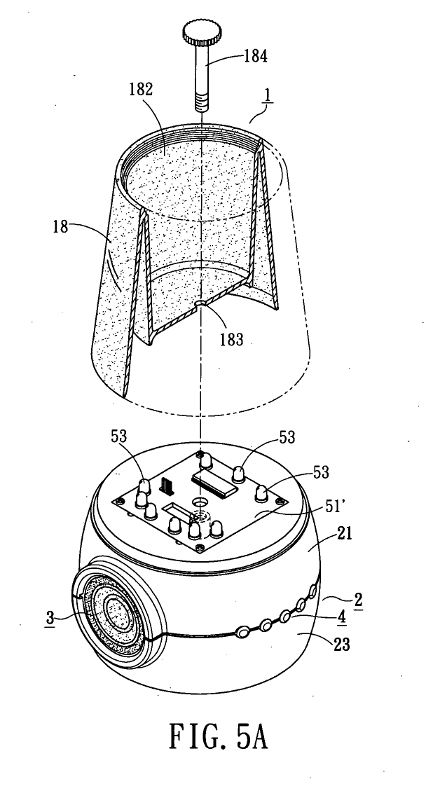

As shown in FIGS. 4-6B, a multimedia luminous speaker comprising a speaker base (2); at least a speaker (3) installed inside the speaker base (2); a control circuit (5) is electrically connected to a speaker (3) in the speaker base (2). At least an LED (53) installed on a circuit board (51′) is fixed to a lateral side of a proximal end of the speaker base (2). A transparent or semi-transparent shade (1) is coupled to the proximal end of the speaker base (2) at a distance to the LED (53). The shade (1) is substantially shaped as a container (18), which has a trough (182) at a center. A bracket (181) fixed at a distal end of the container (18) is screwed to the speaker base (2), Or a hole (183) formed through the distal end of the container (18) allows a dead bolt (184) passed through, and the container (18) is screwed to the speaker base (2) by the dead bolt (184).

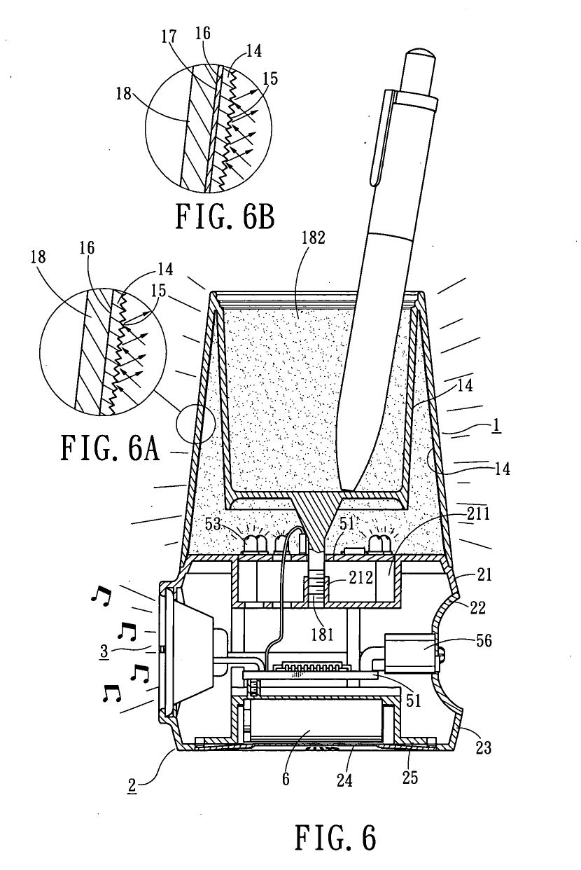

A film (14) attached to an inner side of the container (18) (as shown in FIG. 6). A first side of the film is a glossy surface (16), a second side of the film is a textured surface (15) processed through rollers to form a lot of concave and convex conic dots. The conic dots are able to reflect light to form a lot of speckles (light dots), which is less harsh to the eyes to increase hazy atmosphere.

As mentioned above, the glossy surface (16) of the film (14) can be attached to the container (18) (as shown in FIG. 6A), or the textured surface (15) attached to the container (18) (not shown). Both of them can show luminous effect of the LED.

Next, the glossy surface (16) of the film (14) is preferably processed through screen printing with fine pitch printability to form a film like printing layer (17) (as shown in FIG. 6B) with characters, patterns and marks distributed thereon to fit in occasions. (as shown in FIG. 6B).

As mentioned above, a film (14) is made of polyethylene (PE) with high transparency, fine pitch printability, and electric insulation. The film (14) is therefore inexpensive and durable in use. A thickness of the film is in the range of 0.15˜0.5 mm. Therefore, it can remain transparency, tenacity and toughness, not easy to damage but still bouncing.

As mentioned above, LED (53) can be a full-color or single color to fit in different occasions.

As mentioned above, the speaker base (2) includes a holder (211), a hood (21) fits around the holder (211) and a hole (212) at a center, a base (23) made of plastic fits around a battery pack (25) made of plastic, a battery door (24) for sealing an opening of the battery pack (25), several batteries (6) installed inside the opening of the battery pack (25). A socket shield (22) is installed between the hood (21) and the base (23). The hole (212) allows a bracket (181) or a dead bolt (184) passed through to screw to a distal end of the container (18). Thereby, the speaker base (2) as a whole can hold the container (18) further to protect for example, the circuit board, or the battery pack; even an extra power source can be provided therewith. It is also easily to carry-on.

As mentioned above, a control circuit (5), a connection port (55), and a switch (4) are as same as the first embodiment, no further description for them.

Other than luminous light and sound effects are similar to the first embodiment, but the trough (182) of container (18) is designed for personal belonging and stationeries, for example, pen, put therein (as shown in FIG. 6).

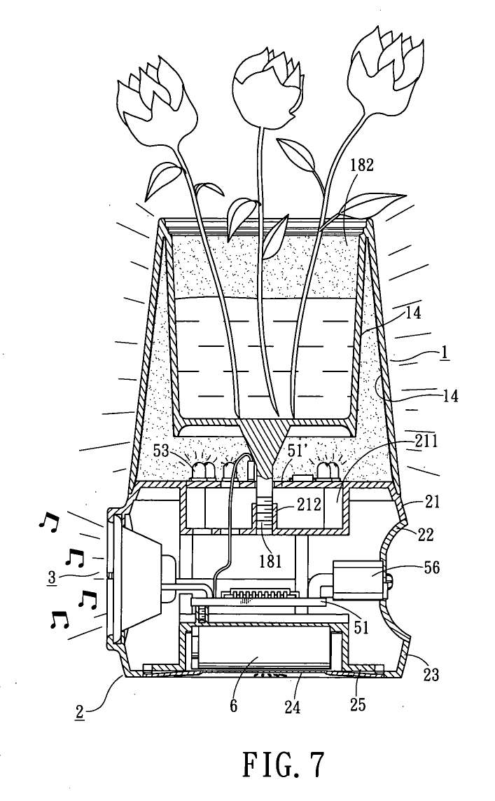

As shown in FIG. 7, a shade (1) can be used as a vase for small plants or handicraft flowers as adornment of the speaker. The shade (1) also can be shaped as a box for deposited money, paper clips or small plants, it is quite practical.

### Third Embodiment

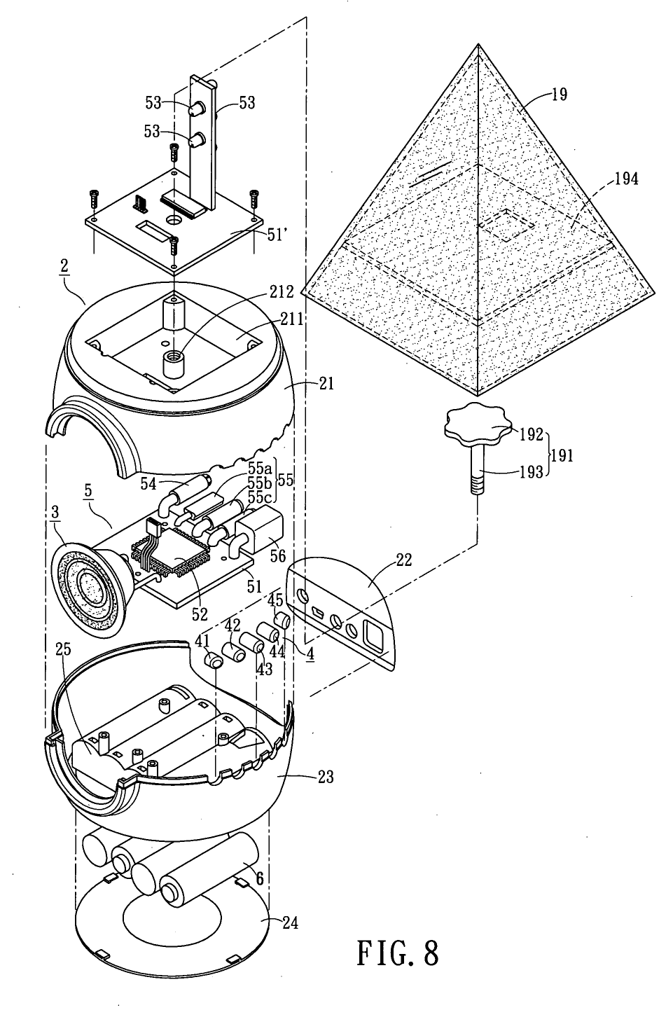

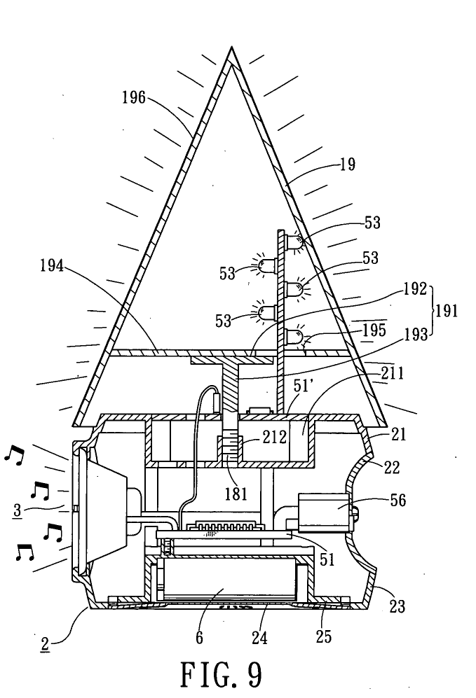

As shown in FIGS. 8-9, a multimedia luminous speaker comprising a speaker base (2); at least, a speaker (3) installed in the speaker base (3); a control circuit (5) is electrically connected to the speaker (3) in the speaker base (2). At least an LED (53) is electrically connected to the control circuit (5) in the speaker base (2). A bracket (191) incorporated to the speaker base (1); a transparent or semi-transparent shade (1) disposed on the bracket (191), the shade (1) is shaped as a hollow adornment (19) made of plastic to receive LED (53) therein, the hollow adornment (19) can be shaped as a pyramid, and it also can be changed into different shapes.

As mentioned above, the bracket (191) consists of a screws bolt (193) with a support plate (192) placed on a proximal end. The support plate (192) has a proper area to support the hollow adornment (19).

As mentioned above, the adornment (19) has a plate (194) at a distal end in contact with the bracket (191). A gap (195) opened downward from the distal end allows LED (53) inserting inside the hollow adornment (19).

Next, a film-like printing layer distributed on an outer surface of the hollow adornment (19) by screen printing, which is endowed with fine pitch printability not to affect transparency of the hollow adornment (19). Colorful patterns and marks printing out surely can show off on the hollow adornment (19) as demanded.

As mentioned above, LED(s) (53) are vertically and intermittently arranged in a row on both left and right sides (or branches) are inserted into the hollow adornment (19). LED(s) (53) can be full-color LED or single color LED to fit in different occasions.

As mentioned above, the speaker base (2) includes a holder (211), a hood (21) fits around the holder (211) and a hole (212) at a center, a base (23) made of plastic fits around a battery pack (25) made of plastic, a battery door (24) for sealing an opening of the battery pack (25), several batteries (6) installed inside the opening of the battery pack (25). A socket shield (22) is installed between the hood (21) and the base (23). The hole (212) allows a bracket (181) or a dead bolt (184) passed through to screw to a distal end of the container (18). Thereby, the speaker base (2) as a whole can hold the container (18) further to protect for example, the circuit board, or the battery pack; even an extra power source can be provided therewith. It is also easily to carry-on.

As mentioned above, the control circuit (5), the connection port (55), switch (4) and auditory-visual achievements are similar to the first and the second embodiments; there has no further description about them. In addition, the hollow adornment (19) shows light emission of LED(s) may change the customer stereotype about speakers and increase practical function.

### ADVANTAGES OF EMBODIMENTS OF THE INVENTION

By embodiment of the invention, advantages can be achieved as following:

1. A bolt (11) inserted through a central bore on a proximal end of the hollow shade (12) and then a distal end of the bolt (11) screwed to the speaker base (2), thereby, the hollow shade (12) is coupled to the base (2). This bolt (11) made of acrylic or polycarbonate passed through the speaker base (2), not only the hollow shade (12) can be secured to the base (2), but also the bolt (11), at least, pervious to light in part, can guide or reflect light throughout the shade (12) and the bolt (11), the hollow shade (12) can fluctuate series of flashing sequences.

2. Shade (1) has a film (14), of which the textured surface is provided with tiny concave and convex conic dots to reflect light, thereby creating speckles (light of dots) to avoid flashlight from directly failing audience's eyesight. Furthermore, a blurred vision may be demonstrated by the speckles, which is in harmony with music broadcast in the speaker can do a relaxation and provide an auditory-visual achievement.

3. Glossy surface of the film (14) is distributed with a film-like printing layer, which is accompany of characters, patterns, or marks simultaneously fade-in or fade-out responding to the tempo of music broadcast in the speaker and the LED(s) show colors alternatively.

4. Layer (13) pervious to light is made of polyvinyl chloride (PVC) with a certain degree of plasticity, flexibility, and strength; it can endure impacts, no damages or cracks can be happened to the layer (13). Furthermore, the film (14) is made of polyethylene (PE) with a certain degree of plasticity and flexibility. The film (14) coupled to the layer (13) can improve strength of the shade (1).

5. Built-in MP3/MP4 decoders (58) of the system chip (52) incorporated to the music broadcast system is ready to perform sound quality performance.

6. Connection port (55) has sound line-in port (55b) and sound line-out port (55c), other than music broadcast system, they can be connected in series with the other multimedia luminous speaker to achieve stereo channel effect. LED(s) of the speakers connected in series are in coordination with one another to light or not to light in response to the same tempo. Each speaker has a plurality of connection ports (55), which can be used to connect to different music broadcast devices.

7. Batteries (66) and power source socket (56) are available to facilitate the speaker being brought to everywhere in person.

8. Container (18) has a trough (182), which can be used to receive pens. Furthermore, the container (18) is coupled to the speaker base (2), and the container (18) can demonstrate series of flashing sequence.

9. Bracket (181) under the container (18) is screwed to the speaker base (2) to support the container (18), and personal belongings put in the container (18), such as pens.

10. Bracket (191) is screwed to the speaker base (2) by the bolt (193), a support plate (192) on the bracket (191) is used to support the adornment (19).

What is claim claimed:

1. A multimedia luminous speaker comprising:
a speaker base (2);
at least a speaker (3) installed on the speaker base (2);
a control circuit (5) installed inside the speaker base (2) electrically connected to the speaker (3); and
at least, an LED (53) installed inside the speaker base (2) electrically connected to the control circuit (5);
wherein a transparent or semi-transparent shade (1) coupled to the speaker base (2) keeps a distance to the LED (53) in the speaker base (2); the shade (1) has a hollow shade (12) made of plastic; the shade (1) fixed to the speaker base (2) by a bolt (11) fit through a central bore at a proximal end of the hollow shade (12) and then a distal end of the bolt (11) screwed to the speaker base (2).

2. A multimedia luminous speaker as claim 1 claimed wherein a hollow shade is cone-shaped shade consists of a layer (13) pervious to light and a film (14); a first side of the film (14) is a glossy surface (16), and a second side of the film (14) is a textured surface (15), which is processed through rollers to form a lot of tiny concave and convex conic dots, the layer (13) pervious to light is made of polyvinyl chloride (PVC), while the film is made of polyethylene (PE).

3. A multimedia luminous speaker as claim 1 claimed wherein the bolt (11) is made of acrylic or polycarbonate, a distal end of the bolt (11) has a tapered prop (112) with external threads; an apex block (111) is on a proximal end of the bolt (11).

4. A multimedia luminous speaker as claim 1 claimed wherein the film (14) is attached to the layer (13) pervious to light by the textured surface (15).

5. A multimedia luminous speaker as claim 1 claimed wherein the film (14) is attached to the layer (13) pervious to light by the glossy surface (16), the film (14) is distributed with a film-like printing layer on the glossy surface (16).

6. A multimedia luminous speaker as claim 1 claimed wherein the speaker base (2) includes a hood (21) made of plastic, a base (23) made of plastic coupled to the hood (21); a socket shield (22) coupled between the hood (21) and a rear end of the base (23); a plastic battery pack (25) opened downward in the base (23); an opening of the plastic battery pack (25) can be sealed by a battery door (24).

7. A multimedia luminous speaker as claim 6 claimed wherein the control circuit (5) includes a circuit board (51) installed inside the speaker base (2), at least, a switch (4) installed on the circuit board (51) protruded out of the speaker base (2); a light-sensitive knob (54) installed inside the socket shield (22) electrically connected to the circuit board (51), a power jack (56), and several connection ports (55); the circuit board (51) is also electrically connected to batteries (6) in the battery pack (25), LED (53) and the speaker (3).

8. A multimedia luminous speaker as claim 7 claimed wherein the connection ports (55) can be selected from one of the following or both: a mini USB port (55a), audio line-in port (55b) and audio line-out port (55c).

9. A multimedia luminous speaker as claim 7 claimed wherein the switch (4) can be selected from one of the following or both: a power switch (41) for the speaker, a volume up button (42), a volume down button (43), a knob (44) for adjusting various level of light color, and a power switch (45) for the LED(s).

10. A multimedia luminous speaker as claim 7 claimed wherein the circuit board (51) includes an amplifier (57), a moving picture experts group third and/or fourth generations compressed file (MP3/MP4) decoder (58), a system chip (52) of a microprocessor (59) for light emission of LED (53) and sound volume of speaker (3) in response to music sound output signals.

11. A multimedia luminous speaker comprising:
a speaker base (2);
at least, a speaker (3) installed inside the speaker base (2);
a control circuit (5) installed inside the base (2) electrically connected to the speaker (3); and
at least, an LED (53) installed inside the speaker base (2) electrically connected to the control circuit (5);
wherein a transparent or semi-transparent shade (1) coupled to the speaker base (2) to keep a distance to the LED (53) of the speaker base (2), said shade (1) is a cylindrical container with a trough (182) formed therein.

12. A multimedia luminous speaker as claim 11 claimed wherein a bracket (181) is extended out of a distal end of the container (18), which is screwed to the base (2) by the bracket (181).

13. A multimedia luminous speaker as claim 11 claimed wherein a distal end of the container (18) has a hole (183) for passing through a bolt (184), the container (18) is fixed to the base (2) by the bolt (184).

14. A multimedia luminous speaker as claim 11 claimed wherein the film (14) made of polyethylene (PE) is attached to an inner side of the container (18), a first side of the film (14) is a glossy surface (16), a second side of the film (14) is a textured surface (15), which is processed through rollers to form a lot of concave and convex conic dots.

15. A multimedia luminous speaker as claim 14 claimed wherein the film (14) attached to the container (18) by the textured surface (15).

16. A multimedia luminous speaker as claim 14 claimed wherein the film (14) attached to the container (18) by the glossy surface (16), a film-like printing layer (196) distributed on the glossy surface (16) of the film (14).

17. A multimedia luminous speaker as claim 11 claimed wherein the base (2) includes a hood (21) made of plastic, a base (23) made of plastic coupled to the hood (21), and a socket shield (22) coupled between the hood (21) and a rear end of the base (23); the hood has a hole (212) for passing through the bracket (181) at the distal end of the container (18) to receive the bolt (184) screwed therein; a battery pack (25) opened downward in the base (23); an opening of the battery pack (25) can be sealed by the battery door (24)

18. A multimedia luminous speaker comprising:
a speaker base (2);
at least a speaker (3) installed inside the speaker base (2);
a control circuit (5) installed inside the speaker base (2) electrically connected to the speaker (3); and
at least an LED (53) installed inside the speaker base (2) electrically connected to the control circuit (5);
wherein a transparent or semi-transparent shade (1) disposed on a bracket (191), which is coupled to the speaker base (2); the shade (1) is a hollow adornment (19), in which the LED(s) (53) are hidden from view.

19. A multimedia luminous speaker as claim 18 claimed wherein the bracket (191) consists of a bolt (193), a support plate (192) is placed on a proximal end of the bolt (193), the adornment (19) has a distal end (194) in contact with the bracket (191); the distal end (194) has a gap (195) for receiving the LED(s) (53) into the adornment (19); a surface of the adornment (19) is distributed with a film-like printing layer (196).

20. A multimedia luminous speaker as claim 18 claimed wherein the base (2) includes a hood (21), a base (23) made of plastic coupled to the hood (21); a socket shield (22) coupled between the hood (21) and a rear end of the base (23); the hood has a hole (212) for receiving the bracket (191) screwed therein; a battery pack (25) opened downward in the base (23), an opening of the battery pack (25) can be sealed by the battery door (24).
